(19) United States
(12) Patent Application Publication
(10) Pub. No.: US 2025/0379238 A1
(43) Pub. Date: Dec. 11, 2025

(54) NITRIDED TERNARY PLATINUM (Pt) CONTAINING NANOPARTICLE CATALYST FOR FUEL CELLS

(71) Applicant: Toyota Motor Engineering & Manufacturing North America, Inc., Plano, TX (US)

(72) Inventors: Liang Wang, Saline, MI (US); Li Qin Zhou, Okemos, MI (US); Kotaro Sasaki, Hauppauge, NY (US); Xueru Zhao, New York, NY (US)

(73) Assignees: Toyota Motor Engineering & Manufacturing North America, Inc., Plano, TX (US); Toyota Jidosha Kabushiki Kaisha, Aichi-ken (JP); Brookhaven Science Associates, LLC, Upton, NY (US)

(21) Appl. No.: 18/734,793

(22) Filed: Jun. 5, 2024

(51) Int. Cl. H01M 4/92; H01M 4/86

(52) U.S. Cl. CPC H01M 4/926; H01M 4/8657; H01M 4/921; H01M 4/923; H01M 2004/8689

(57) ABSTRACT

Disclosed are catalysts having high activity, stability, and durability, methods for making, and fuel cells comprising the catalysts. The catalysts include nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support comprising a predetermined hierarchical pore distribution architecture (MPC-HPDA). The nitrided ternary platinum (Pt) containing nanoparticles have an average particle diameter between about 3.0 nm and about 8.0 nm. The predetermined hierarchical pore distribution architecture of the mesoporous carbon support comprises a plurality of pores with a majority percentage of the plurality of pores having an average pore diameter between about 3.0 nm to about 8.0 nm, and at least a portion of the nitrided ternary platinum (Pt) containing nanoparticles is disposed within the majority percentage of the plurality of pores having an average diameter between about 3.0 nm to about 8.0 nm.

### STATEMENT REGARDING FEDERALLY SPONSORED RESEARCH OR DEVELOPMENT

The present application was made with government support under contract number DE-SC0012704 awarded by the United States Department of Energy. The United States government has certain rights in the invention(s).

### TECHNICAL FIELD

The present disclosure generally relates to catalysts, and particularly to nitrided PtNiCON intermetallic catalyst (IM-PtNiCON) loaded on mesoporous carbon having high activity and stability for polymer electrolyte membrane fuel cells.

### BACKGROUND

Fuel cell vehicles (FCVs) are considered to be more efficient than conventional internal combustion engine vehicles. Current commercially available fuel cell vehicles use polymer electrolyte membrane fuel cells (PEMFCs), which have attracted attention as an energy source for transportation instead of conventional internal combustion engines because they have a high-power density, operate at low temperatures, and have zero emission of harmful gases. Oxidation-reduction reactions (ORR), also known as redox reactions, are central to converting chemical energy into electrical energy. These reactions occur at two electrode layers, the anode and the cathode, separated by a proton exchange membrane. During fuel cell operation, the anode is supplied with hydrogen as a fuel and oxygen as an oxidant to the cathode. Then, fuel is oxidized to protons at the anode, and oxygen is reduced to water at the cathode to generate electricity.

Platinum catalysts are used in both the anode and cathode layers to facilitate the ORR reaction and to provide chemical stability, corrosion resistance, and durability to the fuel cell. In particular, platinum-containing catalysts provide excellent catalytic properties for the reduction of oxygen at the cathode which is important because the ORR is kinetically slower and more complex than the hydrogen oxidation reaction that occurs at the anode. Thus, the catalyst at the cathode is a main factor that determines the power generation characteristics of the PEMFC, and improving its ORR activity and performance is an important issue.

Binary platinum-based alloy catalysts have been reported to have improved ORR activity, but such catalysts have been shown to lack long-term durability under fuel cell operating conditions due to a lack of the ability to stabilize transition metals in Pt-based alloys under acidic ORR conditions. Other challenges with platinum-containing catalysts include platinum particle agglomeration, dissolution, and poisoning of anode and/or cathode materials of the PEMFC, which can lead to reduced ORR activity of the catalyst and overall efficiency of the fuel cell.

Thus, it would be desirable to develop PEMFC electrode catalyst having superior ORR catalytic activity, while maintaining stability and durability.

### SUMMARY

This section provides a general summary of the disclosure and is not a comprehensive disclosure of its full scope or all of its features.

In various aspects, the present teachings provide a catalyst comprising nitrided ternary platinum (Pt) containing nanoparticles having an intermetallic L1₀ structure (IM-PtNiCON) loaded on a mesoporous carbon support comprising a predetermined hierarchical pore distribution architecture (abbreviated herein as “MPC-HPDA”). The nitrided ternary nanoparticles contain platinum (Pt), nickel (Ni), and cobalt (Co). The nitrided ternary platinum (Pt) containing nanoparticles have an average particle diameter between about 3.0 nm and about 8.0 nm. In some examples, the nitrided ternary platinum (Pt) containing nanoparticles have an average diameter between about 4.0 nm and about 7.0 nm.

The nitrided ternary platinum (Pt) containing nanoparticles have a core/shell structure, wherein the core comprises the intermetallic L1₀ structure (IM-PtNiCON) particles loaded on the mesoporous carbon support comprising a predetermined hierarchical pore distribution architecture (MPC-HPDA) encompassed by a platinum shell.

The predetermined hierarchical pore distribution architecture of the mesoporous carbon support comprises a plurality of pores with a majority percentage of the plurality of pores having an average pore diameter between about 3.0 nm to about 8.0 nm, and at least a portion of the nitrided ternary platinum (Pt) containing nanoparticles is disposed within the majority percentage of the plurality of pores having an average diameter between about 3.0 nm to about 8.0 nm. In some examples, the majority percentage of the plurality of pores of the mesoporous carbon support are mesopores having an average diameter between about 3.0 to 8.0 nm is more than 70%. In some examples, the plurality of pores of the mesoporous carbon support comprises between about 5% and about 30% of micropores having an average diameter of less than about 3.0 nm. In some examples, the plurality of pores of the mesoporous carbon support comprises between about 10% and about 25% of micropores having an average diameter less than about 3.0 nm. In at least one example, the plurality of pores of the mesoporous carbon support comprises between about 5% to about 30% micropores with an average diameter of less than about 3.0 nm; the plurality of pores of the mesoporous carbon support comprises between about 50% to about 95% mesopores with an average diameter between about 3.0 nm and about 8.0 nm; and the plurality of pores of the mesoporous carbon support comprises less than about 25% of macropores with an average diameter greater than about 8.0 nm. In other aspects, the present teachings provide a method for making a catalyst for a fuel cell, wherein the catalyst comprises nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support comprising a predetermined hierarchical pore distribution architecture (MPC-HPDA). The method comprises annealing a mixture of metal precursors and the mesoporous carbon comprising a predetermined hierarchical pore distribution under a NH₃ gas flow at a temperature between about 400°° C. to about 820° C. for up to about 9 hours. The metal precursors, comprise platinum, nickel, and cobalt metals. In some examples, the annealing is a temperature between about 560° C. to about 620° C. In some examples, the annealing is between about 5 hours to about 9 hours. In some examples, the annealing is at a temperature of 620° C. for 5 hours. The nitrided ternary platinum (Pt) containing nanoparticles have an average diameter between about 3.0 nm to about 8.0 nm. The predetermined hierarchical pore distribution architecture of the mesoporous carbon support comprises a plurality of pores with a majority percentage of the plurality of pores having an average diameter of less than about 8.0 nm, and at least a portion of the nitrided ternary (Pt) containing nanoparticles are disposed within the majority percentage of the plurality of pores having an average diameter between about 3.0 nm to about 8.0 nm. In some examples, the nitrided ternary platinum (Pt) containing nanoparticles have an average diameter between about 4.0 nm and about 5.0 nm.

The nitrided ternary platinum (Pt) containing nanoparticles have a core/shell structure. The core comprises said intermetallic L1₀ structure (IM-PtNiCON) particles loaded on the mesoporous carbon support comprising a predetermined hierarchical pore distribution architecture (MPC-HPDA) encompassed by a platinum shell. For the mesoporous carbon support comprising a predetermined hierarchical pore distribution architecture the majority percentage of the plurality of pores of the mesoporous carbon support are mesopores having an average diameter between about 3.0 nm and 8.0 nm. In some examples, the majority percentage of the plurality of pores of the mesoporous carbon support having an average diameter between about 3.0 to 8.0 nm is more than 70%. In some examples, the plurality of pores of the mesoporous carbon support comprises between about 5% and about 30% of micropores having an average diameter of less than about 3.0 nm. In some examples, the plurality of pores of the mesoporous carbon support comprises between about 10% and about 25% of micropores having an average diameter of less than about 3.0 nm. In at least one example, the pores of the mesoporous carbon support comprise between about 5% to about 30% micropores with an average diameter of less than about 3.0 nm; the pores of the mesoporous carbon comprise between about 50% to about 95% mesopores with an average diameter between about 3.0 nm and about 8.0 nm; and the pores of the mesoporous carbon comprise less than about 25% of macropores with an average diameter greater than about 8.0 nm.

In another aspect, the present teachings provide a fuel cell comprising: an anode, a cathode, and a polymer electrolyte membrane disposed between the anode and the cathode; and a cathode catalyst disposed on the cathode. The cathode catalyst comprises nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support comprising a predetermined hierarchical pore distribution architecture (MPC-HPDA). The nitrided ternary platinum (Pt) containing nanoparticles have an average diameter between about 3.0 nm to about 8.0 nm, and the predetermined hierarchical pore distribution architecture of the mesoporous carbon support comprises a plurality of pores with a majority percentage of the plurality of pores having an average diameter of less than about 8.0 nm, and at least a portion of the nitrided ternary platinum (Pt) containing nanoparticles are disposed within the majority percentage of the plurality of pores having an average diameter less than about 8.0 nm. In at least one example, the plurality of pores of the mesoporous carbon support comprises between about 5% to about 30% micropores with an average diameter of less than about 3.0 nm; the plurality of pores of the mesoporous carbon comprises between about 50% to about 95% mesopores with an average diameter between about 3.0 nm and about 8.0 nm; and the plurality of pores of the mesoporous carbon comprises less than about 25% of macropores with an average diameter greater than about 8.0 nm.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1 is a schematic illustration of an example of a polymer electrolyte membrane fuel cell (PEMFC).

FIG. 2 is a schematic cross-sectional view of an example of a membrane electrode assembly (MEA).

FIG. 3 is an illustration of a reaction coordinate graph diagram that provides an energy profile for the electrochemical reduction of oxygen on a Pt (111) surface, illustrating the sequence of intermediate states and the corresponding changes in free energy.

FIG. 4A is a schematic illustration of a typical PEMFC.

FIG. 4B is an illustration of an enlarged view of an interface section labeled 4B in FIG. 1A.

FIG. 4C is an illustration of an enlarged view of a traditional carbon support particle loaded with Pt-containing nanoparticles at the interface in FIG. 4B.

FIG. 5A is a schematic illustration of an enlarged view of a mesoporous carbon support particle of the present disclosure having a predetermined hierarchical pore distribution architecture.

FIG. 5B is a schematic illustration of an enlarged view of a composite particle of the present disclosure comprising a mesoporous carbon support particle having a predetermined hierarchical pore distribution architecture and the nitrided ternary Pt-containing nanoparticles of the present disclosure disposed within the plurality of pores of the mesoporous carbon support.

FIG. 5C is a schematic illustration of an enlarged view of section 5C labeled in FIG. 5B.

FIG. 6 is an illustration of a Time-Temperature-Transformation (T-T-T) diagram of the PtNiCON system of the present disclosure.

FIG. 7 shows a plot of intensity versus angle for an x-ray diffraction (XRD) scan of IM-PtNiCON catalyst of the present disclosure showing an intermetallic peak (110) peak at 33.6°.

FIG. 8 is a schematic illustration of the intermetallic L1o structure of the IM-PtNiCON catalyst of the present disclosure.

FIG. 9 is a schematic illustration of the atomic structure of IM-PtNiCON/MPC-HPDA core/shell nanoparticles of the present disclosure comprising a Pt shell on an intermetallic PtNiCON core.

FIG. 10 is a HAADF-STEM (High-angle Annular Dark Field Scanning Electron Microscopy) image of (100) plane IM-PtNiCON/MPC-HPDA core/shell nanoparticles of the catalyst of the present disclosure where Pt is represented by the brighter circles and the darker circles represent Ni or Co.

FIG. 11 illustrates a plot of intensity versus angle for an X-ray diffraction (XRD) scan of sample S1 containing an IM-PtNiCoN/MPC-HPDA catalyst of the present disclosure showing an intermetallic peak (110) peak at 33.6° and having an average particle size of about 4.3 nm.

FIG. 12 is an illustration of a plot of the Barrett-Joyner-Halenda (BJH) pore size analysis of KetjenBlack, a commercial mesoporous carbon.

FIG. 13 illustrates a plot of intensity versus angle for an X-ray diffraction (XRD) scan of sample S2 containing a SS-PtNiN/KB catalyst having an average particle size of about 9.3 nm. A characteristic peak indicating an ordered intermetallic structure is not present.

FIG. 14 illustrates a plot of intensity versus angle for an X-ray diffraction (XRD) scan of sample S3 containing a SS-PtNiCoN/MPC-HPDA catalyst having an average particle size of about 3.3 nm. A characteristic peak indicating an ordered intermetallic structure is not present.

FIG. 15 illustrates a plot of intensity versus angle for an X-ray diffraction (XRD) scan of sample S4 containing an IM-PtNiCON/MPC-HPDA catalyst having an average particle size of about 2.0 nm. A characteristic peak indicating an ordered intermetallic structure is not present.

FIG. 16 illustrates a plot of intensity versus angle for an X-ray diffraction (XRD) scan of sample S5 containing an IM-PtNiCON/MPC-HPDA catalyst having an average particle size of about 2.3 nm. A characteristic peak indicating an ordered intermetallic structure is not present.

FIG. 17 illustrates a plot of intensity versus angle for an X-ray diffraction (XRD) scan of sample S6 containing an IM-PtNiCON/MPC-HPDA catalyst having an average particle size of about 16.0 nm. A characteristic peak indicating an ordered intermetallic structure is present, but the particle size is too big.

FIG. 18 illustrates a plot of intensity versus angle for an X-ray diffraction (XRD) scan of sample S7 containing an IM-PtNiCON/MPC-HPDA catalyst having an average particle size of about 11.4 nm. A characteristic peak indicating an ordered intermetallic structure is present, but the particle size is too big.

FIG. 19 is a graphical illustration of mass activity measured using the membrane electrode assembly (MEA) technique for sample S1 of Example 1 containing an IM-PtNiCoN/MPC-HPDA catalyst of the present disclosure as compared to Sample S2 containing a SS-PtNiN/KB catalyst (comparative example).

FIG. 20 is a graphical illustration of the nickel (Ni) retention rate measured using the X-ray fluorescence (XRF) before and after an accelerated stress test (AST) for sample S1 of Example 1 containing an IM-PtNiCON/MPC-HPDA catalyst of the present disclosure as compared to Sample S2 containing a SS-PtNiN/KB catalyst (comparative example).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

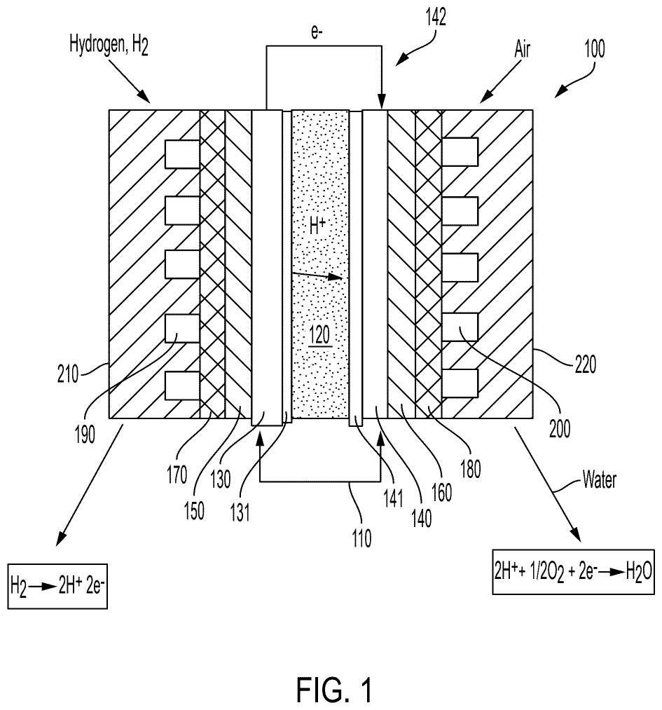

The present disclosure provides an electrode catalyst (also referred to herein as a “catalyst material”) having enhanced activity for oxidation-reduction reactions (“ORR”), which can advantageously be used as a cathode catalyst in polymer electrolyte membrane fuel cells (“PEMFCs”) for improved activity and stability. FIG. 1 presents one representation of an example of a fuel cell 100. The fuel cell 100 includes a membrane-electrode assembly (MEA) 110 comprising a proton exchange membrane (PEM) 120, positioned between an anode 130 and a cathode 140, and an external electrical circuit 142 that electrically connects the anode 130 and the cathode 140. A first microporous layer 150 (also referred to herein as an “anodic microporous layer” (AMPL) contacts the anode 130. An anode gas diffusion layer (AGDL) 170 contacts the first microporous layer 150 and a first flow channel 190 contacts the anode gas diffusion layer 170. A second microporous layer (also referred to herein as a “cathodic microporous layer” (CMPL) 160 contacts the cathode 140. A cathode gas diffusion layer (CGDL) 180 contacts the second microporous layer 160 and a second flow channel 200 contacts the cathode gas diffusion layer 180. An anode bipolar plate 210 may contact the first flow channel 190 and a cathode bipolar plate 220 may contact the second flow channel 200.

The fuel gas is typically hydrogen. The hydrogen gas may be stored in a storage tank. Optionally, hydrogen may be stored as metal hydrides or may be hydrogen obtained by reforming a hydrocarbon fuel. The oxidizing gas is typically an oxygen-containing gas. In some embodiments, the oxidizing gas is ambient air. Hydrogen and air flow within the cell are illustrated in FIG. 1. Hydrogen (H₂) is fed to the anode side of the fuel cell and an oxygen source (such as ambient air) is fed to the cathode side of the fuel cell. In FIG. 1, water and excess air are depicted as exiting the cathode side of the fuel cell, and unreacted hydrogen is shown as exiting the anode side of the fuel cell.

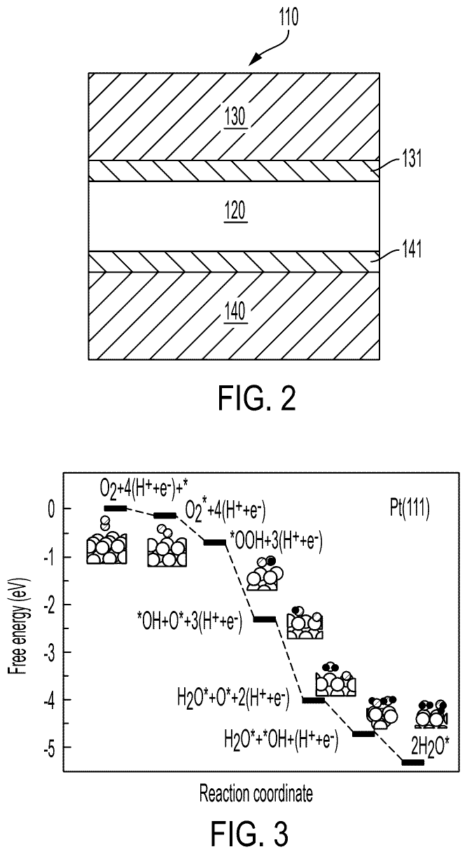

FIG. 2 is an illustration of the membrane-electrode assembly (MEA) 110 comprising a proton exchange membrane 120, an anode 130, and a cathode 140. The anode 130 comprising an anodic catalyst layer 131, configured to electrolytically catalyze an anodic hydrogen-splitting reaction:

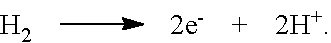

The anodic catalyst layer can be substantially formed of anodic catalyst particles of platinum, or a platinum alloy supported on carbon, such as carbon black.

The cathode 140, comprises a cathodic layer 141, configured to catalyze an oxygen reduction reaction:

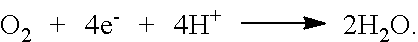

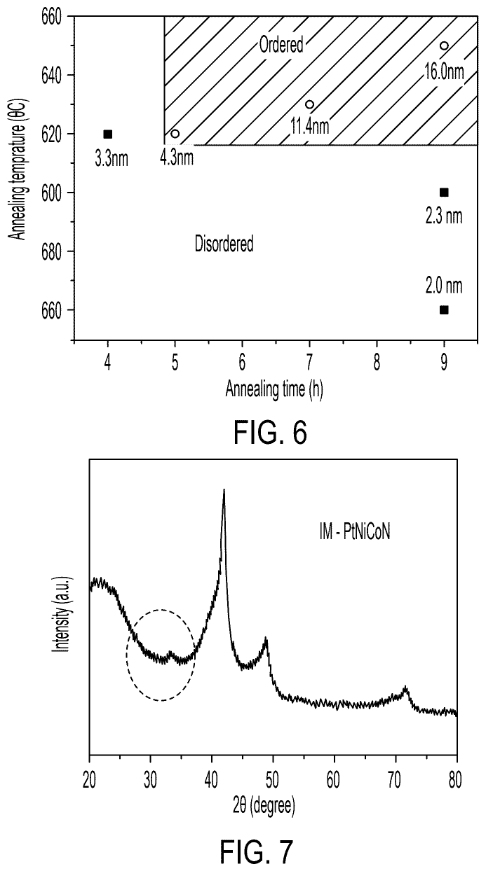

Platinum is widely used as a cathode catalyst in electrochemical reactions, such as in fuel cells, because of its exceptional ability to speed up the oxygen reduction reaction (ORR). The graph in FIG. 3 illustrates how platinum acts as an efficient catalyst during the electrochemical reduction of oxygen in a PEMFC by lowering the activation energy, stabilizing intermediates, and steering the ORR towards a more efficient and desired chemical pathway, thus significantly enhancing the overall reaction kinetics and thermodynamics on the Pt (111) surface. In the initial state, O₂+4H⁺+4e→*, molecular oxygen (O₂) is adsorbed onto the platinum surface. This state involves the transfer of four protons (H⁺) and four electrons (e) to the platinum surface, preparing the oxygen molecule for further reduction. As the graph descends, it shows the formation of *OOH (hydroperoxide) and subsequently *OH (hydroxyl) and *O (atomic hydrogen) intermediates. The oxygen molecule is further reduced and adsorbed on the platinum surface as an intermediate species, denoted as O₂*. The initial energy state at this step is around 0 eV. In the next step, the O₂* species further reacts with a proton and an electron to form the hydroperoxide radical (*OOH) on the surface. This step results in a decrease in free energy, indicating that the formation of *OOH is energetically favorable. The *OOH intermediate undergoes additional reduction, losing an oxygen atom and forming two separate adsorbed species: hydroxyl (*OH) and atomic oxygen (*O). At this step there is a significant drop in free energy. One *O atom reacts with a hydroxyl group (OH) and additional protons and electrons to form a water molecule (H₂O) while leaving another *OH on the platinum surface. Platinum catalyzes these steps by providing a surface that facilitates the transfer of electrons and protons to the adsorbed oxygen species, progressively reducing and splitting the molecule. In the final step the remaining *OH group is converted into another water molecule through the reaction with another proton and electron, resulting in two adsorbed water molecules on the surface. The presence of platinum ensures that the reaction follows the four-electron pathway directly to water. This is represented by the decline in energy as intermediate species are transferred stepwise into water molecules. As can be seen in the graph in FIG. 6, throughout the reaction pathway, free energy decreases, indicating that the reaction is an exergonic reaction, (i.e., releases energy). The lowest energy state is reached with the formation of two (2) water molecules indicating this as the most stable product of this reaction pathway on Pt (111).

Platinum's unique surface properties not only adsorb and activate the reactants but also stabilize the intermediate reaction species, allowing controlled and sequential reaction steps as depicted in FIG. 3. Previous approaches to producing catalyst particles with a higher catalytic activity and reduced loading of costly precious metals have typically involved the use of one or more components that are susceptible to corrosion in alkaline or acidic environments such as PtM, where M is a transition metal such as Ni, Co, or Fe. Over time, the gradual loss of these elements and their subsequent buildup in other critical components present within the energy conversion device, e.g., an electrolyte membrane, reduces both the activity level of the catalyst particles and the overall efficiency of the device.

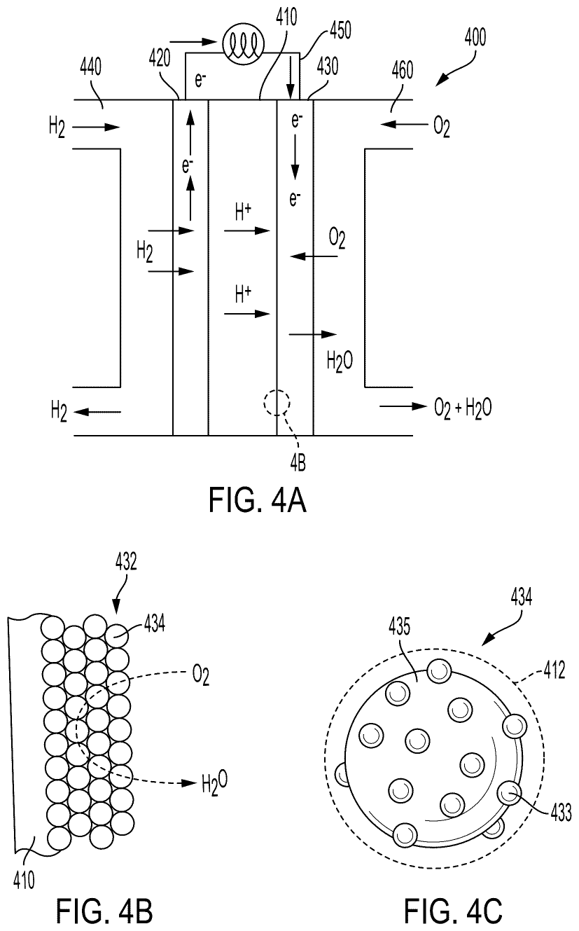

FIGS. 4A-4C illustrate the components and operation of a typical PEMFC 400. The PEMFC 400 in FIG. 4A includes a PEM 410 sandwiched between an anode 420 and a cathode 430, and an external electrical circuit 450 that electrically connects the anode 420 and the cathode 430. The cathode 430 includes a catalyst layer 432 with a plurality of composite particles 434 as illustrated in FIG. 4B, and the composite particles 434 include a plurality of Pt-containing nanoparticles 433 supported on the surface of carbon particles 435 as illustrated in FIG. 4C (only one carbon particle 435 shown). During operation of the PEMFC 400, hydrogen (H₂) gas is provided to and flows through an anode-side inlet 440 and oxygen (O₂) gas (e.g., O₂ in air) is provided to and flows through a cathode-side inlet 460. At least a portion of the H₂ flows into contact with the anode 420 and migrates to the PEM 410 where H₂ molecules are catalyzed into H⁺ ions plus electrons ‘e⁻’ (e.g., via an anode catalyst layer—not shown). Also, at least a portion of the O₂ gas flows into contact with the cathode and migrates to the PEM 410. The electrons e− flow through the external electrical circuit 450 to the cathode 430 and react with O₂ molecules to form O₂₋ ions (e.g., via the cathode catalyst layer 432) and the H⁺ ions diffuse through the PEM 410 to the cathode 430 and react with the O₂₋ ions to form H₂O (water), which is then transported out of the PEMFC 400 with the flow of unreacted O₂. In this manner, the Pt-containing nanoparticles 433 assist in and enhance the reaction of O2+e− to O₂₋ and/or O₂₋+H+ to H₂O and electricity is generated by the PEMFC 400.

Referring specifically to FIG. 4C, in some examples an ionomer 412 from the PEM 410 is in contact with and at least partially surrounds the composite particles 434. And in such examples, the ionomer 412 can poison the plurality of Pt-containing nanoparticles 433 (also known as “ionomer poisoning”) such that the efficiency of the catalyst layer 432 decreases. In addition, the plurality of Pt-containing nanoparticles 435 supported on an outer surface of the carbon particle 435 can agglomerate and/or increase in size such that an average effective size of the Pt-containing nanoparticles increases and the efficiency of the catalyst layer 432 decreases. That is, increasing the average particle size of the Pt-containing particles reduces the surface area to volume ratio of the Pt-containing particles, which in turn reduces the surface area available to catalyze the O₂+e− to O₂₋ and/or O₂₋+H+ to H₂O reaction(s). Accordingly, ionomer poisoning and nanoparticle growth, either by agglomeration or particle size growth, are problematic for PEMFCs.

Previous efforts to develop PEMFC catalysts involve binary platinum-based (PTB) alloy nanoparticles, PtM, where M is a transition metal such as Ni, Co, or Fe, which exhibited improved ORR activity. However, such BPT catalyst lacked sufficient durability in long term operation of a PEMFC due to a lack of the ability to stabilize transition metals under acidic ORR conditions. For example, among various reported PTB alloy catalysts having high ORR activity and membrane electrode assembly (MEA) performance, PtNi₃ exhibited significant Ni degradation (only ˜15% Ni remained) during an accelerated durability test (ADT).

Ordered intermetallic PtM-based nanoparticles, where M is a transition metal, have attracted attention for providing significantly improved activity and durability for ORR. Compared to alloy nanoparticles, ordered intermetallic PtM-based nanoparticles show a strong atomic interaction between Pt and M leading to high chemical and structural stability, and modulation of the composition ratio of M to Pt to achieve higher mass activity (MA) for the ORR. Recent density functional theory studies have shown that both the linear compressional and shear strain effects provided by 3D alloying elements in PtM contribute to the optimal adsorption on the reaction intermediates. Thus, it is considered that inducing tensile strains within the Pt surface of PtM catalysts will improve the ORR kinetics. However, too much tensile strain can damage the structure of PtM catalysts and the stability of the ORR. Therefore, controlling tensile strain is important. Anion doping, such as nitrogen-doping (N-doping) is a strategy used to provide optimal strain fields on the surface of the Pt shell. Additionally, the anion dopant reacts with the core compounds to form a metal nitride core and form chemically stable core compounds.

The present inventors previously developed a nitrogen-doped (“N-doped”), or nitrogen-stabilized (“N-stabilized”), ternary catalyst loaded on a carbon support and demonstrated that N-doped PtNiN/C catalysts exhibited higher activity and durability compared with PtM alloy catalysts. A carbon support can be effective to protect catalysts from agglomeration of nanoparticles and improve the conductivity and stability of the catalyst and the present inventors have studied employing a commercial mesoporous carbon, such as Ketjenblack (KB), as a support for Pt-containing catalysts as a way to improve ORR activity, stability, and durability. The present inventors previously developed solid-solution (SS) and intermetallic (IM) N-doped PtNiN catalysts supported on commercial KB carbon (PtNiN/KB) and demonstrated that the PtNiN/KB catalysts showed enhanced ORR activity and durability compared with PtNi/C catalysts. See, for example, U.S. Pat. Nos. 9,822,222, 10,501,321, and 10,680,249, incorporated herein by reference in its entirety. However, the present inventors observed that the N-doped PtNiN catalysts supported on a mesoporous support having a predetermined (hierarchical pore distribution architecture (abbreviated herein as “HPDA”) designed to increase catalytic activity further as compared to commercial KB carbon, did not form an ordered intermetallic structure under the same synthesis conditions.

To address this problem, the present disclosure provides an electrode catalyst for PEMFCs which comprises nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support having a predetermined hierarchical pore distribution architecture (MPC-HPDA). As used in the present disclosure, the term “nitrided” refers to the catalyst material wherein nitrogen is incorporated, doped, or included within the core and/or shell via nitridation using ammonia (NH₃) so as to form a metal nitride core. The present inventors have discovered that the combination of (i) a nitrided (ii) ternary platinum-containing catalyst comprising platinum, nickel, and cobalt having an intermetallic ordered core/shell structure on (iii) a mesoporous carbon having a predetermined hierarchical pore distribution architecture has a synergistic effect and provides significant improvement in ORR activity, stability and durability, MEA performance, and overall PEMFC performance for further commercialization of FCVs as compared to PtNiN/KB and other Pt-containing binary catalysts as well as other Pt-containing ternary catalysts.

The nitrided ternary platinum (Pt) containing nanoparticles of the present disclosure have a core/shell structure wherein the core particles are encompassed by a platinum shell. The core comprises intermetallic L1₀ structured (IM-PtNiCON) particles loaded on the mesoporous carbon support having a predetermined hierarchical pore distribution architecture (MPC-HPDA). As used herein, “intermetallic L1₀ structured” refers to the compound structure wherein the metallic elements have a defined stoichiometry and ordered crystal structure characterized by a specific regular, periodic arrangement of the different metal atoms in alternating layers along one axis, while maintaining a face centered cubic (fcc) arrangement perpendicular to that axis. The intermetallic L1₀ structure can be confirmed by X-Ray diffraction (XRD) and is identified by a characteristic peak 33.3°. The intermetallic L1₀ structured core influences electronic properties and surface energies and provides structural stability to the nanoparticles. The structural stability helps prevent the degradation of the platinum shell during ORR reaction conditions leading to corrosion-resistance of the core, which contributes to the heightened catalytic activity and improved durability of the electrocatalytic nanoparticles of the present disclosure. It is believed that the enhanced activity and durability are attributable at least partly to geometric and electronic effects, in which the presence of a nitride within the non-noble metal core suppresses core dissolution during potential cycling and reduces lattice contraction leading to an up-shifted noble metal d-band center. While not wishing to be bound by any particular theory, the analysis described herein reveals that nitride-induced contraction strengthens oxygen binding at nanoparticle surfaces compared to a non-noble metal core alone yet increases lattice contraction leading to a down-shifted noble metal d-band center compared to the noble metal alone.

The nanoparticle cores may be spherical or spheroidal in shape It is to be understood, however, that the particles may take on any shape or structure which includes, but is not limited to branching, conical, pyramidal, cubical, cylindrical, nanowires, mesh, fiber, octahedral, cuboctahedral, icosahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size may be configured to maximize surface catalytic activity. In an embodiment the nanoparticle cores have external dimensions of less than 12 nm along at least one of three orthogonal directions. Throughout this specification, the exemplary nanoparticles will be primarily disclosed and described as substantially spherical in shape.

The platinum shell is a thin layer of platinum with 1-4 Pt monolayers Once nanoparticles having the desired shape, composition, and size distribution have been fabricated, the desired shell layer may then be formed. The particular process used to form the shell layer is not intended to be limited to any particular process but is generally intended to be such that it permits formation of films having thicknesses in the monolayer-to-multilayer thickness range. It is to be understood, however, that while the process of preparing core-shell nanoparticles is described sequentially, the cores and the shells of the core-shell nanoparticles can also be formed in parallel.

For purposes of this specification, a monolayer (ML) is formed when the surface of a substrate, e.g., a nanoparticle, is fully covered by a single, closely packed layer comprising adatoms of a second material which forms a chemical or physical bond with atoms at the surface of the substrate. The surface is considered fully covered when substantially all available surface sites are occupied by the adatoms of the second material. The surface may be considered fully covered when more than 90% of all available surface sites are occupied by the adatoms of the second material, or when more than 95% of all available surface sites are occupied by the adatoms of the second material. When more than about 90% of all available surface sites are occupied, the shell is considered to be continuous and nonporous. If less than 90% of the surface sites of the substrate are not completely occupied, then the surface coverage is considered to be sub monolayer (or may be non-continuous). However, if a second layer or subsequent layers of the adsorbant are deposited onto the first layer, then multilayer surface coverages, e.g., bilayer, trilayer, etc., result and are considered continuous and nonporous. Multilayer surface coverages may result and be considered continuous and nonporous cumulatively together, whereas individually each layer may be non-continuous.

The nitrided ternary platinum (Pt) containing nanoparticles have an average particle diameter between about 3.0 nm and about 8.0 nm, between about 3.0 nm and about 7.0 nm, between about 3.0 nm and about 6.0 nm, between about 3.0 nm and about 5.0 nm, between about 3.0 nm and about 4.0 nm; between about 4.0 nm and about 8.0 nm, between about 4.0 nm and about 7.0 nm, between about 4.0 nm and about 6.0 nm, between about 4.0 and about 5.0 nm, between about 3.3 nm and about 7.7 nm, between about 4.3 nm and about 6.7 nm, between about 3.3 nm and about 6.3 nm, between about 4.3 nm and about 5.3 nm, between about 3.3 nm and about 4.3 nm.

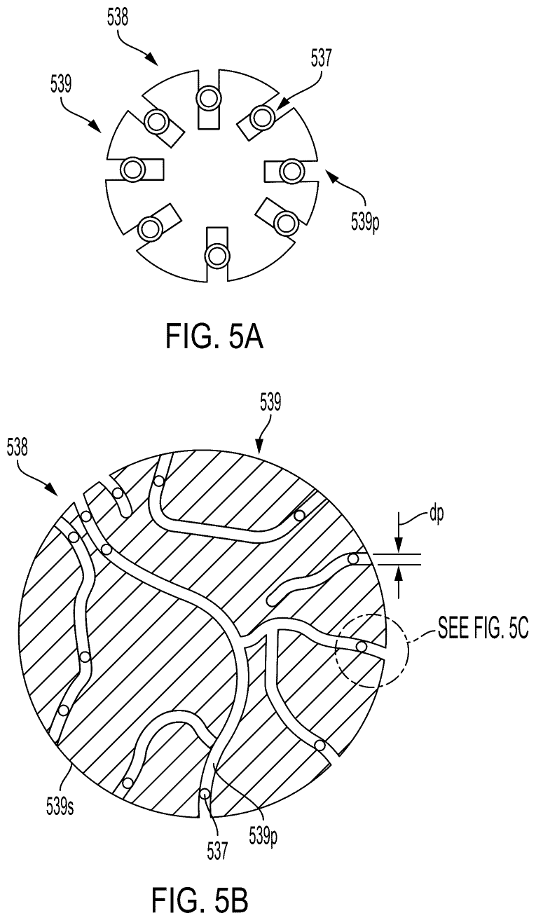

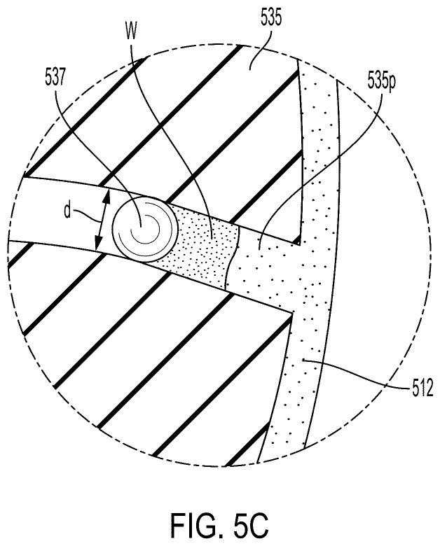

The mesoporous carbon support of the present disclosure has a predetermined hierarchical pore distribution architecture which enhances the activity of the catalyst material. FIGS. 5A-5C illustrate mesoporous carbon support particles 539 having a predetermined hierarchical pore distribution architecture of the present disclosure. The predetermined hierarchical pore distribution architecture is such that the mesoporous carbon support particles 535 comprise a plurality of pores 539p, or openings, and at least a portion of the nitrided ternary platinum (Pt) containing nanoparticles 537 is disposed within or fit tightly within the plurality of pores 539p. The predetermined hierarchical pore distribution architecture of the mesoporous carbon support of the present disclosure comprises a majority percentage of the plurality of pores 539p, having an average pore diameter, dp, between about 3.0 nm to about 8.0 nm, and at least a portion of the nitrided ternary platinum (Pt) containing nanoparticles 537 is disposed and fit tightly within the majority percentage of the plurality of pores 539p having an average diameter between about 3.0 nm to about 8.0 nm. In some examples, the plurality of pores of the mesoporous carbon support are mesopores having an average diameter between about 3.0 to 8.0 nm is more than 70%, between about 50% to about 95% mesopores with an average diameter between about 3.0 nm and about 8.0 nm.

The predetermined hierarchical pore distribution architecture of the mesoporous carbon support also comprises between about 5% and about 30% of micropores having an average diameter of less than about 3.0 nm. In some examples, the predetermined hierarchical pore distribution architecture of the mesoporous carbon support comprises between about 10% and about 25%, or between about 5% to about 30% micropores with an average diameter of less than about 3.0 nm. The predetermined hierarchical pore distribution architecture of the mesoporous carbon support may also comprise less than about 25% of macropores with an average diameter greater than about 8.0 nm. In some examples, the mesoporous carbon support of the present invention has a predetermined hierarchical pore distribution architecture wherein the plurality of pores of the mesoporous carbon support comprises between about 5% to about 30% micropores with an average diameter of less than about 3.0 nm; between about 50% to about 95% mesopores with an average diameter between about 3.0 nm and about 8.0 nm; and less than about 25% of macropores with an average diameter greater than about 8.0 nm.

Referring to FIGS. 5A-5C, the composite particles 538 include a plurality of mesoporous carbon particles 539 and a plurality of Pt-containing nanoparticles 537 loaded within pores 539p of the mesoporous carbon particles 539. And while not shown in FIGS. 5B-5C, it should be understood that Pt-containing nanoparticles 537 can be loaded onto and supported by an exterior surface 139s of the mesoporous carbon particles 539.

A majority of the pores 539p of the mesoporous carbon particles 139 have an average pore diameter such that the Pt-containing nanoparticles 537 are disposed within the pores 539p with a “tight fit.” As used herein, the phrase “tight fit” refers to a difference between the average pore diameter of the pores 139p and the average diameter of the Pt-containing nanoparticles 537 being less than 10 nanometers (nm). For example, in at least one example a difference between the average pore diameter of the pores 539p and the average diameter of the Pt-containing nanoparticles 537 is less than 5 nm, and in some examples a difference between the average pore diameter of the pores 539p and the average diameter of the Pt-containing nanoparticles 537 is less than 2.5 nm.

In some examples the Pt-containing nanoparticles 537 are nitrogen-doped platinum nickel cobalt (PtNiCON) nanoparticles 537 with an average particle size between about 3.0 nm and about 8.0 nm. In some examples, the Pt-containing nanoparticles 537 are generally spherical in shape, while in other examples the Pt-containing nanoparticles 537 are not generally spherical in shape. For example, the Pt-containing nanoparticles 537 are generally cuboidal in shape, generally cylindrical in shape, among others. In at least one example, the PtNiCON nanoparticles 537 are core-shell nanoparticles with a PtNiCON core and a Pt shell. In other examples, the PtNiCON nanoparticles 537 have a PtNiCON core decorated with islands of Pt and/or PtN, i.e., Pt and/or PtN islands are supported on the PtNiCON Core, and the Pt and/or PtN islands may or may not be discrete nanoparticles.

In examples where the Pt-containing nanoparticles 537 have an average particle size between about 3.0 nm and about 8.0 nm, at least 85% of the pores 539p of the mesoporous carbon particles 539 have an average pore diameter less than about 8.0 nm. And in at least one example, at least 90% of the pores 539p of the mesoporous carbon particles 539 have an average pore diameter less than about 8.0 nm. For example, in some examples the mesoporous carbon particles 539 have a pore size distribution of between 5-30% micropores with an average pore diameter less than 3.0 nm, between 50-95% mesoporous with an average pore diameter between 3.0 nm and 8.0 nm, and between 0-25% macropores with an average pore diameter greater than 8.0 nm.

In at least one example, the mesoporous carbon particles 539 have a pore size distribution of 10-25% micropores with an average pore diameter less than about 3.0 nm, more than 70% mesopores with an average pore diameter between about 3.0 nm and about 8.0 nm, and less than 10% macropores with an average pore diameter greater than about 8.0 nm. And in some examples, the mesoporous carbon particles 539 have a pore size distribution of 15-20% micropores with an average pore diameter less than about 3.0 nm, more than 75% mesopores with an average pore diameter between about 3.0 nm and about 8.0 nm, and less than 7.5% macropores with an average pore diameter greater than about 8.0 nm. In addition, the mesoporous carbon particles have a BET surface area greater than 1,000 m²/g, for example, between about 1,000 m²/g and 2,000 m²/g.

Not being bound by theory, the tight fit between the average pore diameter of the pores 539p and the average diameter of the Pt-containing nanoparticles 537 results in enhanced mass activity of the composite particles 538 due to limited space for the Pt containing nanoparticles 537 within the pores 539p to agglomerate and/or grow in size. In addition, the tight fit provides or enables a boundary layer of water ‘w’ to be present between the Pt-containing nanoparticles 537 and the ionomer 512 as illustrated in FIG. 5C such that the Pt-containing nanoparticles 537 are spaced apart from the ionomer 512 and thereby are protected or shielded from ionomer poisoning. For example, and as noted above, operation of the PEMFC results in the Pt-containing nanoparticles 537 catalyzing O₂⁻ and H⁺ to form H₂O such that water is formed proximate to and displaces ionomer 512 in contact with the Pt-containing nanoparticles 537. Accordingly, the tight fit between the average pore diameter of the pores 539p and the average diameter of the Pt containing nanoparticles 537 decreases agglomeration and/or growth of the Pt-containing nanoparticles 537, and/or decreases or prevents ionomer poisoning of the Pt-containing nanoparticles 537.

The nitrided ternary platinum (Pt) containing core/shell nanoparticles of the present disclosure can be prepared by any technique known in the art. U.S. Pat. Nos. 9,882,222, 10,501,321, and 10,680,249, which are incorporated herein by reference in their entirety, describe general synthesis methods for forming nitrogen-doped platinum containing catalysts. A one step synthesis method is described by L. Song, et al., “One-Step Facile Synthesis of High Activity Nitrogen-Doped PtNiN oxygen Reduction Catalyst,” ACS Appl. Energ. Mater. 5, 5245-5255 (2022), and a synthesis method for an intermetallic N-doped binary platinum containing catalyst is described by Zhao, et al., “High-Performance Nitrogen-Doped Intermetallic PtNi Catalyst for the Oxygen Reduction Reaction,” ACS Catal. 10, 10637-10645 (2020), each of which is incorporated herein by reference in their entirety.

Once core-shell nanoparticles having the desired shape, composition, and size distribution have been fabricated, the nitrogen may then be introduced into the core. The particular process used to introduce nitrogen into the core is not intended to be limited to any particular process but is generally intended to permit formation of a metal nitride within the core. It is to be understood, however, that while the process of preparing nitride stabilized core-shell nanoparticles is described sequentially, the process of introducing nitrogen into the core can also be done during the core formation, during the shell formation, or both.

The metal nitride formation within the core may be initiated by thermal annealing the core-shell nanoparticles for 1 to 20 hours, followed by exposing the core-shell nanoparticles to a nitrogen precursor at elevated temperatures and ambient pressure for a time sufficient to form a metal nitride. In one embodiment, the amount of metal nitride within the core is between about 20 and 100% wt. %. In another embodiment, the amount of metal nitride within the core is between about 30 and 100% wt. %. In yet another example, the amount of metal nitride within the core is between about 30 and 80% wt. %.

The nitrogen source is not particularly limited and can be selected from urea, ammonia (NH₃), dinitrogen (N₂), nitric oxide (NO), and hydrazine (N₂H₄). In certain embodiments, the nitrogen source is ammonia. The core-shell nanoparticles may be thermally annealed at about 200, 250, or 300° C. in nitrogen (NH₃) gas for about 1-5 hours, followed by thermal annealing at a range between about 400-820° C., particularly at about 400, 410, 420, 430, 440, 450,460, 470, 480, 490 500, 510, 520, 530, 540, 550,560, 570, 580, 590, 600, 610, 620, 630, 640, 650, 660, 670, 680, 690, 700, 710, 720, 730,740, 750, 760, 770, 780, 790, 800, 810, or 820° C. in ammonia (NH3) for up to about 9 hours, particularly between about 5-9 hours. Although both dinitrogen and ammonia may be used in such process, it is believed that ammonia functions as a precursor of nitrogen in the formation of the metal nitride. The manufacturing process is simple and cost-effective, providing nitride-stabilized nanoparticles with higher catalytic activities and improved durability in combination with minimal loading of precious materials compared to catalysts currently in use.

In another example, the disclosed nanoparticles are manufactured by a method which involves preparing a mixture which includes an organic solvent, salts of a noble metal and a non-noble transition metal, and optionally a carbon powder. The mixture may be stirred, sonicated and/or deaerated for a period of time, for example from about 1 minute to about an hour or more. The organic solvent may be removed from the mixture by evaporation to form dried powders. In one embodiment, the mixture may be dried completely using a rotary evaporator with a heating bath at 50° C. The dried powders may then be thermally annealed as described above to form a metal nitride core and a thin noble metal shell. In one embodiment, the annealing is performed in ammonia (NH₃) for 2 hours at 500° C. at an ambient pressure. The nitriding treatment for the catalyst can also be carried out using a high-pressure nitriding system at 500° C. at a high pressure up to 10 MPa (1500 psi). Additionally, the annealed powders may be cooled down to room temperature under a NH₃ flow in a closed furnace. The manufacturing process is simple and cost-effective, providing nitride stabilized nanoparticles with still higher catalytic activities and improved durability in combination with minimal loading of precious materials as compared with catalysts currently in use. Because this synthesis procedure does not involve a chemical reduction process in an aqueous solution, the possibility of oxidation of Ni cores is excluded, thereby leading to a higher activity for the ORR.

The mixture may comprise any suitable organic solvent. Examples of suitable organic solvents include but are not limited to acetone, chloroform, benzene, cyclohexane, dichloromethane, ethanol, diethyl ether, ethyl acetate, hexane, methanol, toluene, xylene, oleylamine, mixtures of two or more of these, and derivatives of one or more of these.

The mixture may further comprise any of the metal salts mentioned above. The solution may comprise a soluble salt of Ni, a soluble salt of Co, and a soluble salt of Pt in an organic solution. The soluble salt of Ni may be, for example, Ni(acac)₂. The soluble salt of Co may be, for example, Co(acac)₂ The soluble salt of Pt may be, for example, Pt(acac)₂. Formation of the core/shell nanoparticles may be accomplished by annealing the dried powder at 400 to 820° C. under NH₃ to form a core comprising nickel cobalt nitride NiₓCo₁ₓN (x=3 or 4). In other examples, the shell may comprise Pd, Au, or Ir.

The present inventors found that N-doped PtNiN catalyst material did not form an intermetallic ordered structure when combined with a mesoporous carbon support having the predetermined hierarchical pore distribution architecture described in the present disclosure under the same synthesis conditions. Without being bound by a particular theory, formation of an intermetallic L1₀ ordered structure requires a lot of energy and involves particle growth, however, the mesoporous carbon having a predetermined hierarchical pore distribution architecture as described in the present disclosure, restricts particle growth of N-doped PtNiN nanoparticles. Introducing cobalt (Co) to form a ternary Pt-containing catalyst particle facilitates the formation of an intermetallic ordered structure and improves catalytic activity. Additionally, to form the intermetallic ordered structure of the N-doped ternary platinum-containing catalyst containing platinum, nickel, and cobalt on the mesoporous carbon support having a predetermined hierarchical pore distribution architecture as described in the present disclosure, the synthesis conditions required annealing at a temperature of about 400° C. to about 820° C. for up to 9 hours, in some examples, between 5 to 9 hours.

In the present disclosure to obtain the ternary platinum (Pt) containing nanoparticles comprising platinum (Pt), nickel (Ni), and cobalt (Co) having an intermetallic L1₀ structure (IM-PtNiCON) loaded on the mesoporous carbon support having a predetermined hierarchical pore distribution architecture (MPC-HPDA), the dried precursor mixture undergoes nitridation to become nitrided wherein the intermetallic ordered structure is obtained.

The formation of ordered intermetallic structure is highly dependent on the annealing temperature and time. To obtain the L1₀ ordered intermetallic structure of the pt-containing ternary catalyst of the present disclosure, a dried mixture of the metal precursors and the mesoporous carbon having a predetermined hierarchical pore distribution architecture undergoes annealing under a NH₃ gas flow at a temperature between about 400° C. to about 820° C. for up to about 9 hours. The metal precursors, comprise platinum, nickel, and cobalt metals. In some examples, the mixture of metal precursors comprises platinum (II) acetylacetonate (Pt(acac)₂), nickel (II) acetylacetonate (Ni(acac)₂), and cobalt acetylacetonate (Co(acac)₂). In some examples, the annealing is a temperature between about 560° C. to about 820° C. In some examples, the annealing temperature is between about 560° C. to about 620° C. In some examples, the annealing is between about 5 hours to about 9 hours. In an example, the annealing is at a temperature of 620° C. for 6 hours. When the annealing temperature is at a high temperature such as about 800° C., the annealing time may be shorter such as about 2 hours.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Synthesis

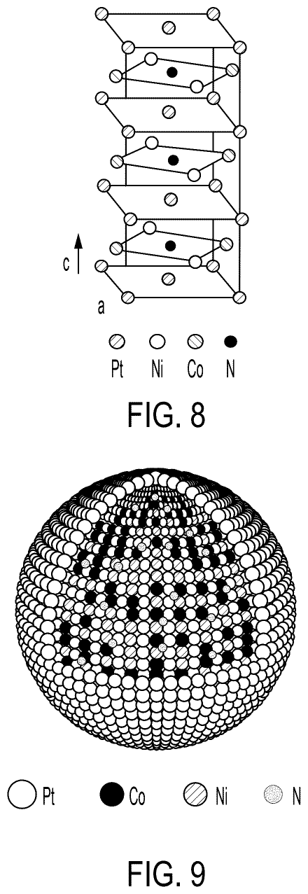

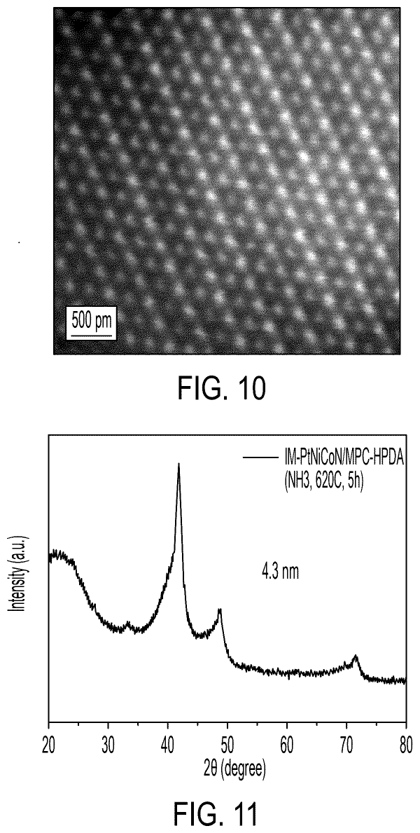

The IM-PtNiCON catalyst was synthesized as follows: 401.3 mg of Pt (II) acetylacetonate (Pt(acac)₂), 135.3 mg Ni acetylacetonate (Ni(acac)₂), 132.6 mg Co acetylacetonate (Co(acac)₂), each purchased from Sigma-Aldrich, and 594 mg of mesoporous carbon provided by Toyota were dispersed in 200 ml of acetone, and then sonicated for 1 hour. The mole ratio of Pt:Co:Ni in precursors is 1:0.5:0.5 (23 wt. % Pt). The mesoporous carbon particles had a BET surface area 1200 m²/g and a hierarchical pore size distribution of about 5-30% micropores (<2 nm) with an average pore diameter less than about 3.0 nm, 50-95% mesopores (2 nm-8 nm) with an average pore diameter between about 3.0 nm and about 8.0 nm, and 0-25% macropores with an average pore diameter greater than about 8.0 nm (“MPC-HPDA”). The suspension was kept at room temperature with magnetic stirring overnight. Then, the mixture was dried by a rotating evaporator device. The dried precursor was then annealed in a tube furnace under flowing NH₃ to form an ordered intermetallic phase. The ordered intermetallic phase of PtNiCo appears at 620° C. or higher temperature and annealing time for 5 h or longer time. A time-temperature-transformation (T-T-T) diagram of the PtNiCON system is shown in FIG. 6. The generation of the ordered intermetallic phase of PtNiCON is confirmed by the appearance of a peak at 33.6° as shown in FIG. 7, which corresponds to the (110) peak of the L1₀ ordered structure illustrated in FIG. 8. The IM-PtNiCON nanoparticle consists of a thin Pt shell on an intermetallic PtNiCON core, as schematically illustrated in FIG. 9. The formation of intermetallic phase is also verified by high-angle annular dark-field scanning transmission electron microscopy (HAADF-STEM) image of (100) plane IM-PtNiCON core/shell nanoparticles of the present disclosure in FIG. 10. In the HAADF-STEM image Pt is represented by the brighter circles and the darker circles represent Ni or Co.

### Example S1. IM-PtNiCoN/MPC-HPDA

The catalyst was prepared as described in the synthesis example above, wherein the dried precursor was annealed at 620° C. for 5 hours. IM-PtNiCON nanoparticles with an average diameter of 4.3 nm loaded onto the mesoporous carbon particles having a predetermined hierarchical pore distribution architecture (MPC-HPDA) of the present disclosure. XRD is provided in FIG. 11 indicating the formation of the intermediate L1₀ phase.

### Example S2. SS-PtNiN/KB

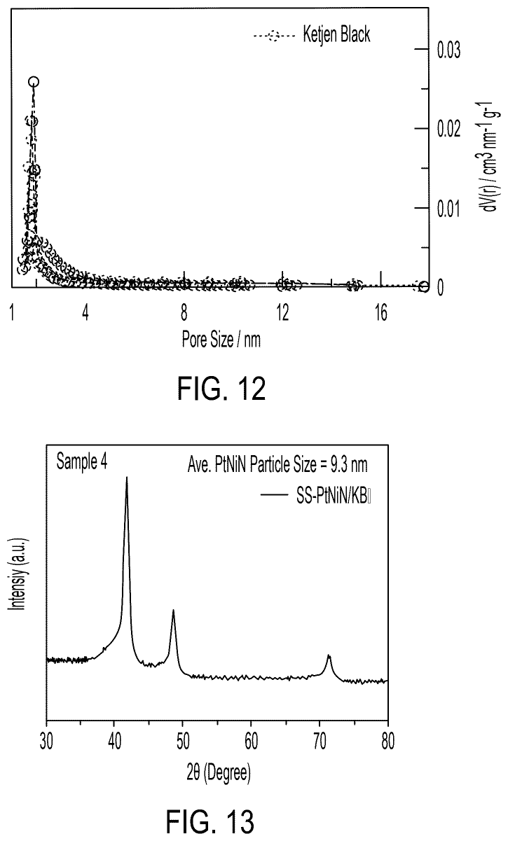

Precursors of PtNiN catalysts were prepared by dispersing 330 mg of Pt(acac)₂, 220 mg Ni(acac)₂ and 500 mg of ketjenblack EC-300J carbon support in 80 mL of acetone, followed by sonication for 2 hours. The resulting suspension was kept at room temperature with magnetic stirring for 2 hours and then the resulting mixture was dried by a rotating evaporator device to provide a dried precursor. The dried precursor was then annealed in a tube furnace under flowing NH₃ at 560° C. for 9 hours. Ketjenblack is a mesoporous carbon having a pore distribution wherein the majority of pores are less than 4 nm. The pore distribution of Ketjenblack is shown in FIG. 12. PtNiN nanoparticles with an average diameter equal to 9.3 nm loaded onto loaded onto ketjenblack EC-300J carbon black particles were obtained. XRD is provided in FIG. 13 showing that an intermetallic ordered phase was not formed.

### Example S3. SS-PtNiCoN/MPC-HPDA

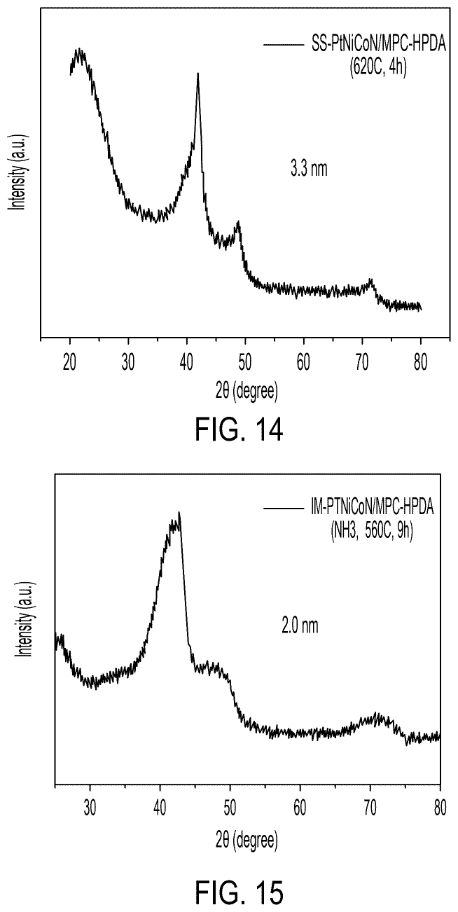

The catalyst was prepared in the same manner as Example S1, except that the dried precursor was annealed at 620° C. for 4 hours. PtNiCON nanoparticles with an average diameter of about 3.3 nm loaded onto mesoporous carbon particles having a predetermined hierarchical pore distribution architecture (“MPC-HPDA”) of the present disclosure. X-Ray Diffraction (XRD) is provided in FIG. 14 indicating that an intermetallic phase was not formed.

### Example S4. IM-PtNiCoN/MPC-HPDA

The catalyst was prepared in the same manner as Example S1, except the dried precursor was annealed at 560° C. for 9 hours. PtNiCON nanoparticles with an average diameter equal to 2.0 nm loaded onto mesoporous carbon particles having a predetermined hierarchical pore distribution architecture (MPC-HPDA) of the present disclosure. XRD is provided in FIG. 15 indicating that an intermetallic phase was not formed.

### Example S5. IM-PtNiCoN/MPC-HPDA

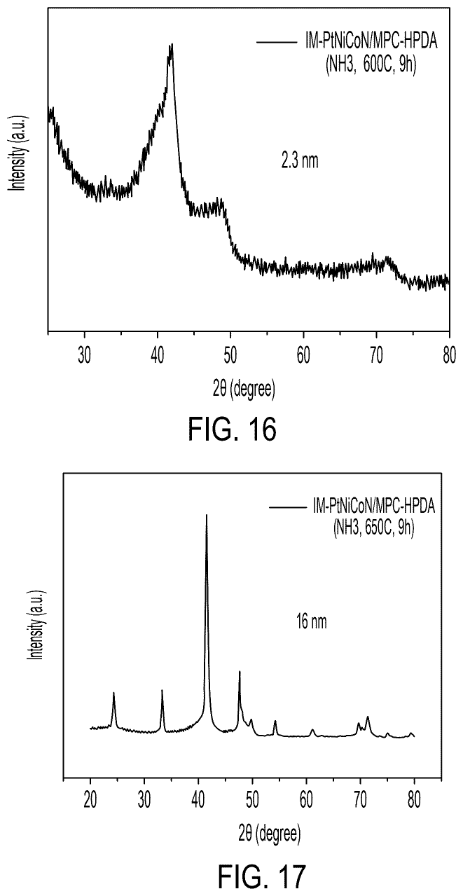

The catalyst was prepared in the same manner as Example S1, except the dried precursor was annealed at 600° C. for 9 hours. PtNiCON nanoparticles with an average diameter equal to 2.3 nm loaded onto mesoporous carbon particles. XRD is provided in FIG. 16 indicating that an intermetallic phase was not formed.

### Example S6. IM-PtNiCoN/MPC-HPDA

The catalyst was prepared in the same manner as Example S1, except the dried precursor was annealed at 650° C. for 9 hours. PtNiCON nanoparticles with an average diameter equal to 16.0 nm loaded onto mesoporous carbon particles having a predetermined hierarchical pore distribution architecture (MPC-HPDA) of the present disclosure. XRD is provided in FIG. 17 indicating that an intermetallic phase was formed. However, the particle size is too large.

### Example S7. IM-PtNiCoN/MPC-HPDA

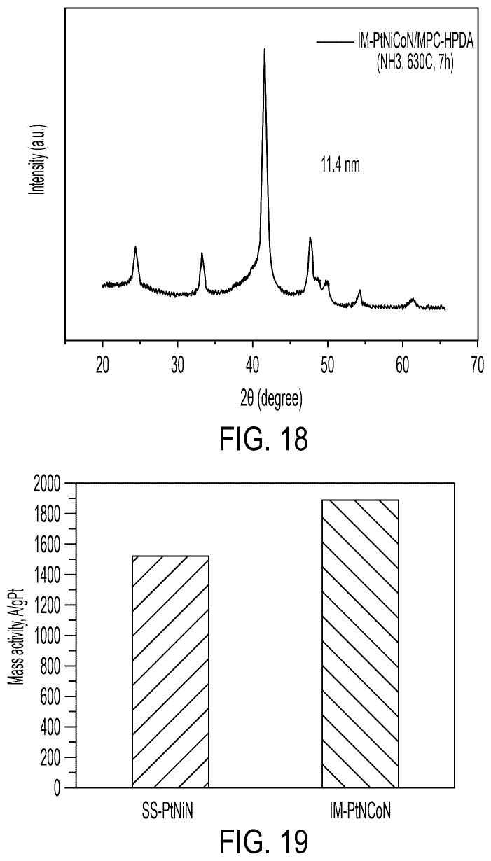

The catalyst was prepared in the same manner as Example S1, except the dried precursor was annealed at 630° C. for 7 hours. PtNiCON nanoparticles with an average diameter equal to 11.4 nm loaded onto mesoporous carbon particles. XRD is provided in FIG. 18 indicating that an intermetallic phase was formed. However, the particle size is too large.

### Example 2. MEA Fabrication

The SS-PtNiN and IM-PtNiCON catalysts were used to be cathode materials and evaluated in the MEA. The catalyst ink consisted of ethanol, water, ionomer, and catalysts. The ionomer to carbon (I/C) weight ratio and the solid content were kept at 0.85. The ink slurry was vigorously mixed and coated on a poly (tetrafluoro-ethylene) substrate (0.002″ thick, Macmaster-CARR) using a doctor-blade casting method. Similarly, a Pt/C (30 wt % Pt content, TEC10EA30E, TKK) catalyst layer with I/C ratio at 0.7 was prepared as the anode material. The coating layer was dried at 80° C. to remove the solvent. The coating layer was dried at 80° C. to remove the solvent. The final anode and cathode Pt loading were controlled at 0.05 and 0.1 mg Pt/cm₂.

Individual cathode and anode electrocatalyst layer (2 cm×2 cm) were punched and sandwiched between a Gore membrane to form a catalyst coated membrane (CCM) using a decal-transfer technique. The hot-pressing condition was 130° C., 0.8 MPa, and 5 mins. The gas diffusion layers (29 BC, SGL Carbon) together with CCM were assembled in a single cell with a serpentine flow field (Scribner Associates).

### Example 3. Rotating Disk Electrode (RDE) Evaluation

The catalyst was dispersed in a solution containing 4 mL DI water, 2.25 mL isopropanol and 25 μL Nafion dispersion (DE520) and the ink was subject to 60 mins ultrasonication in an ice bath. A 10 μL aliquot of this ink was pipetted onto the glassy carbon (GC) disk (5 mm diameter, Pine) and rotationally dried in air to form a uniform catalyst layer. The catalyst coated GC was first pre-conditioned in N₂-saturated 0.1 M HClO₄. Typically, the working disk was scanned from 0.05 V to 1.2 V with a scan rate of 100 mV s−1 until the cyclic voltammetry (CV) curve didn't change. After that, ORR measurements were conducted in the saturated 0.1 M HClO₄ and multiple independent data sets were collected. All the intrinsic activities were corrected with N₂-background and IR compensation.

### Example 4. MEA Evaluation

A 850e Fuel Cell test system (Scribner Associates) was used for the catalyst stability evaluation. The MEAs with SS-PtNiN and IM-PtNiCON catalysts respectively first activated by sweeping between 0.9 V to 0.1 V for several hundred times cycles under H₂/Air (1.5 NLPM/₂ NMPM) at 45° C. and 100% relative humidity (RH).

An accelerated stress test (AST) recommended by DOE was used to evaluate the durability of SS-PtNiN and IM-PtNiCON catalysts. A lower potential of 0.6 V (3 s) and an upper potential of 0.95 V (3 s) was used in square wave for 30,000 cycles in H₂/N₂ (0.2 LPM L/0.2 LPM) at 80° C. and 100% RH. X-ray Fluorescence (XRF) was used to test the Ni content before and after AST.

The mass activity of SS-PtNiN and IM-PtNiCON was compared with RDE (FIG. 19). The IM-PtNiCON shows better activity than SS-PtNiN because of the intermetallic structure and introduction of cobalt help adjust the surface strain of Pt, therefore lower the adsorption of oxygen spices on Pt surface for the oxygen reduction reaction (ORR).

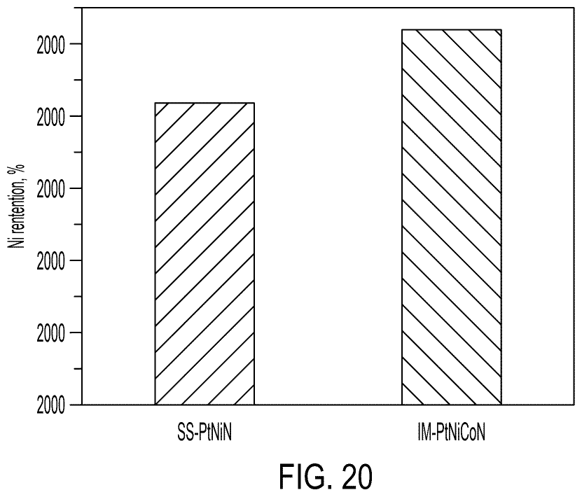

The benefit of the intermetallic structure also helps stabilize the transition metals in the structure. The IM-PtNiCON catalyst shows an improved Ni retention rate as compared to a solid-solution (SS) SS-PtNiN catalyst after a stability test in MEAs (FIG. 20).

The data indicates that the combination of (i) a nitrided (ii) ternary platinum-containing catalyst comprising platinum, nickel, and cobalt having an intermetallic ordered core/shell structure on (iii) a mesoporous carbon having a predetermined hierarchical pore distribution architecture has a synergistic effect and provides significant improvement in ORR activity, stability and durability, MEA performance, and overall PEMFC performance as compared to PtNiN/KB and other Pt-containing binary catalysts as well as other Pt-containing ternary catalysts.

The design of the nitrided ternary platinum-containing catalyst comprising platinum, nickel, and cobalt having an intermetallic ordered core/shell structure on a mesoporous carbon having a predetermined hierarchical pore distribution architecture as described herein provides enhanced catalytic activity and provides structural stability to the nanoparticles, which helps prevent the degradation of the platinum shell during rigorous reaction conditions, which is advantageous for long-term operation in applications like fuel cells, where catalyst degradation can significantly impact performance and lifespan. Such benefits make the catalysts and fuel cells of the present disclosure useful in both the automotive and aviation industries. Other transition metals such as copper (Cu), chromium (Cr), and gallium (Ga) could be used as an alternative to cobalt (Co) to enhance the ordering degree of the intermetallic L1₀ structure of ternary platinum (Pt)-containing catalyst and thereby improve structural and electronic characteristics of the catalysts.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or examples thereof) are not necessarily referring to the same aspect or embodiment. It should also be understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such examples should not be regarded as a departure from the disclosure, and all such modifications are intended to be included within the scope of the disclosure.

What is claimed is:

1. A catalyst comprising:
nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support (MPC-HPDA) comprising a predetermined hierarchical pore distribution architecture,
wherein the nitrided ternary platinum (Pt) containing nanoparticles have an average particle diameter between about 3.0 nm and about 8.0 nm, and
wherein the predetermined hierarchical pore distribution architecture of the mesoporous carbon support comprises a plurality of pores with a majority percentage of the plurality of pores having an average pore diameter between about 3.0 nm to about 8.0 nm, and at least a portion of the nitrided ternary platinum (Pt) containing nanoparticles is disposed within the majority percentage of the plurality of pores having an average diameter between about 3.0 nm to about 8.0 nm.

2. The catalyst according to claim 1, wherein the nitrided ternary platinum (Pt) containing nanoparticles have a core/shell structure and wherein the core comprises the intermetallic L1₀ structure (IM-PtNiCON) nanoparticles loaded on the mesoporous carbon support comprising a predetermined hierarchical pore distribution architecture (MPC-HPDA) encompassed by a platinum shell.

3. The catalyst according to claim 1, wherein the nitrided ternary platinum (Pt) containing nanoparticles have an average diameter between about 4.0 nm and about 7.0 nm.

4. The catalyst according to claim 1, wherein the majority percentage of the plurality of pores of the mesoporous carbon support are mesopores having an average diameter between about 3.0 to 8.0 nm is more than 70%.

5. The catalyst according to claim 1, wherein the plurality of pores of the mesoporous carbon support comprises between about 5% and about 30% of micropores having an average diameter of less than about 3.0 nm.

6. The catalyst according to claim 1, wherein the plurality of pores of the mesoporous carbon support comprises between about 10% and about 25% of micropores having an average diameter of less than about 3.0 nm.

7. The catalyst according to claim 1, wherein:
the plurality of pores of the mesoporous carbon support comprises between about 5% to about 30% micropores with an average diameter of less than about 3.0 nm;
the plurality of pores of the mesoporous carbon support comprises between about 50% to about 95% mesopores with an average diameter between about 3.0 nm and about 8.0 nm; and
the plurality of pores of the mesoporous carbon support comprises less than about 25% of macropores with an average diameter greater than about 8.0 nm.

8. A method for making a catalyst for a fuel cell, wherein the catalyst comprises nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support comprising a predetermined hierarchical pore distribution architecture (MPC-HPDA), said method comprising:
annealing a mixture of metal precursors and the mesoporous carbon comprising a predetermined hierarchical pore distribution under a NH₃ gas flow at a temperature between about 400° C. to about 820° C. for up to about 9 hours,
wherein the metal precursors, comprise platinum, nickel, and cobalt metals,
wherein the nitrided ternary platinum (Pt) containing nanoparticles have an average diameter between about 3.0 nm to about 8.0 nm, and
wherein the predetermined hierarchical pore distribution architecture of the mesoporous carbon support comprises a plurality of pores with a majority percentage of the plurality of pores having an average diameter of less than about 8.0 nm, and at least a portion of the nitrided ternary (Pt) containing nanoparticles are disposed within the majority percentage of the plurality of pores having an average diameter between about 3.0 nm to about 8.0 nm.

9. The method according to claim 8, wherein the nitrided ternary platinum (Pt) containing nanoparticles have a core/shell structure and wherein the core comprises said intermetallic L1₀ structure (IM-PtNiCON) nanoparticles loaded on the mesoporous carbon support comprising a predetermined hierarchical pore distribution architecture (MPC-HPDA) encompassed by a platinum shell.

10. The method according to claim 8, wherein the annealing is a temperature between about 560° C. to about 620° C.

11. The method according to claim 8, wherein the annealing is between about 5 hours to about 9 hours.

12. The method according to claim 8, wherein the annealing is at a temperature of 620° C. for 5 hours.

13. The method according to claim 8, wherein the nitrided ternary platinum (Pt) containing nanoparticles have an average diameter between about 4.0 nm and about 5.0 nm.

14. The method according to claim 8, wherein the majority percentage of the plurality of pores of the mesoporous carbon support are mesopores having an average diameter between about 3.0 nm and 8.0 nm.

15. The method according to claim 8, wherein the majority percentage of the plurality of pores of the mesoporous carbon support having an average diameter between about 3.0 to 8.0 nm is more than 70%.

16. The method according to claim 8, wherein the plurality of pores of the mesoporous carbon support comprises between about 5% and about 30% of micropores having an average diameter of less than about 3.0 nm.

17. The method according to claim 8, wherein the plurality of pores of the mesoporous carbon support comprises between about 10% and about 25% of micropores having an average diameter of less than about 3.0 nm.

18. The method according to claim 8, wherein:
the pores of the mesoporous carbon support comprise between about 5% to about 30% micropores with an average diameter of less than about 3.0 nm;
the pores of the mesoporous carbon comprise between about 50% to about 95% mesopores with an average diameter between about 3.0 nm and about 8.0 nm; and
the pores of the mesoporous carbon comprise less than about 25% of macropores with an average diameter greater than about 8.0 nm.

19. A fuel cell comprising:
an anode, a cathode, and a polymer electrolyte membrane disposed between the anode and the cathode; and a cathode catalyst disposed on the cathode,
wherein the cathode catalyst comprises nitrided ternary platinum (Pt) containing nanoparticles comprising platinum (Pt), nickel (Ni), and cobalt (Co) having an intermetallic L1₀ structure (IM-PtNiCON) loaded on a mesoporous carbon support comprising a predetermined hierarchical pore distribution architecture (MPC-HPDA),
wherein the nitrided ternary platinum (Pt) containing nanoparticles have an average diameter between about 3.0 nm to about 8.0 nm, and
wherein the predetermined hierarchical pore distribution architecture of the mesoporous carbon support comprises a plurality of pores with a majority percentage of the plurality of pores having an average diameter of less than about 8.0 nm, and at least a portion of the nitrided ternary platinum (Pt) containing nanoparticles are disposed within the majority percentage of the plurality of pores having an average diameter less than about 8.0 nm.

20. The fuel cell according to claim 19, wherein:
the plurality of pores of the mesoporous carbon support comprises between about 5% to about 30% micropores with an average diameter of less than about 3.0 nm;
the plurality of pores of the mesoporous carbon comprises between about 50% to about 95% mesopores with an average diameter between about 3.0 nm and about 8.0 nm; and
the plurality of pores of the mesoporous carbon comprises less than about 25% of macropores with an average diameter greater than about 8.0 nm.
